(19) United States
(12) Patent Application Publication
(10) Pub. No.: US 2004/0042029 A1
(43) Pub. Date: Mar. 4, 2004

(54) Data communication device and method

(76) Inventor: Takaaki Hosoda, Tokyo (JP)

Correspondence Address: RABIN & Berdo, PC, 1101 14TH STREET, NW, SUITE 500, WASHINGTON, DC, 20005, US

(21) Appl. No.: 10/647,374

(22) Filed: Aug. 26, 2003

(30) Foreign Application Priority Data
Aug. 26, 2002 (JP) JP2002-244716

(51) Int. Cl. G06F 13/00; G06F 15/00; G06F 11/00

(52) U.S. Cl. 358/1.14; 358/1.15

(57) ABSTRACT

An identification of data sent from the sender is attached automatically to the data by a sending information managing section (11b2). Or, in the occasion when the communication device is made up for attaching such kind of identification by itself; the function of this avails the present invention. And, printing out the same data sent by the sender itself is controlled, when the same data is detected with the identification.

### BACKGROUND OF THE INVENTION

1. Field of the Invention

The present invention relates to a data communication device and method, which can cope with occurrence of communication error adequately.

2. Description of the Related Art

In conventional data communication, if an error occurred in the occasion of sending data, the data sent from the sender to the receiver was returned to the sender from the receiver with an error information. And, all the returned data was put out, that is, printed in paper or presented at display.

However, in this occasion, the returned data is what is sent from the sender to the sender itself. And, the sender knows the content of the returned data. So, this data was put out in vain. That is, for example, print papers were used in vain.

### SUMMARY OF THE INVENTION

The present invention is made to solve the problem mentioned above and to provide means for coping with an error in data communication adequately. That is, a data sent from the sender and returned to the sender itself is a duplicate of a data offered by the user himself or herself. In considering this fact, an adequate solution for this occasion is offered. Therefore, present invention adopts following configuration.

<Configuration 1>

One is a data communication device comprising a data receiving section for receiving data, at least one data outputting section for putting out said data, an its own information detecting section for detecting information which indicates that the sender of said data is the sender, and a controlling section for limiting output of said data to said data outputting section when said its own information detecting section detected said information indicating that the sender of said data is the sender.

<Configuration 2>

The other is a data communication method for detecting information which indicates that the sender of said data is the sender, when an error information is detected from a received data; and limiting output of said received data according to the result of the detection.

### BRIEF DESCRIPTION OF THE DRAWINGS

FIG. 1 is a block diagram showing a configuration of data communication device of Embodiment 1.

FIG. 2 shows an example of electronic mail content.

FIG. 3 is a flow-chart showing the operation of Embodiment 1.

FIG. 4 is a block diagram showing a configuration of data communication device of Embodiment 2.

FIG. 5 is a flow-chart showing the operation of Embodiment 2.

FIG. 6 is a block diagram showing a configuration of data communication device of Embodiment 3.

FIG. 7 is a flow-chart showing the operation of Embodiment 3.

FIG. 8 is a block diagram showing a configuration of data communication device of Embodiment 4.

FIG. 9 is a flow-chart showing the operation of Embodiment 4.

FIG. 10 shows an example of system structure.

FIG. 11 shows an example of normal electronic mail.

### DETAILED DESCRIPTION OF THE PREFERRED EMBODIMENTS

Hereafter, the preferred embodiments according to present invention is described referring to the appended drawings.

<Embodiment 1>

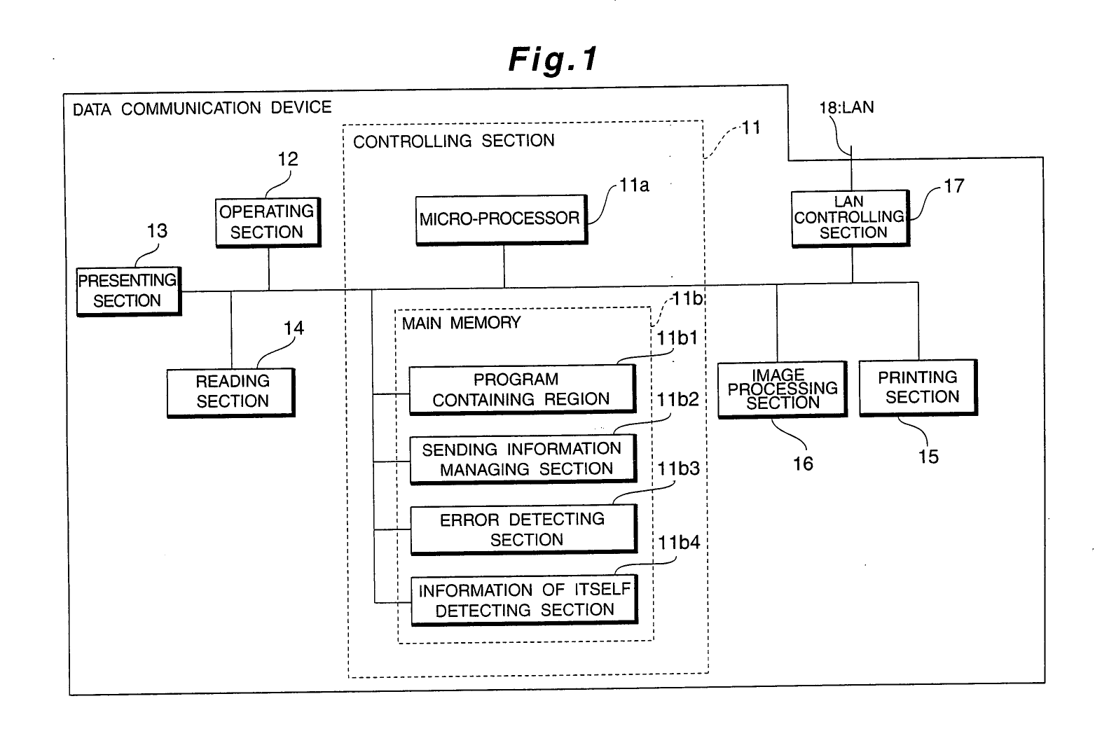

FIG. 1 shows Embodiment 1 of data communication device of present invention.

The device shown in FIG. 1 comprises a controlling section 11, an operating section 12, a presenting section 13, a reading section 14, a printing section 15, an image processing section 16, and LAN controlling section 17.

The controlling section 11 comprises a microprocessor 11a and a main memory 11b. The microprocessor 11a is a processor for performing an over-all control of the data communication device. The main memory 11b is a memory comprising semiconductor etc. In this main memory 11b reserved is a program containing region 11b. In this program containing region 11b contained are softwares corresponding to communication functions of internet or LAN connected with the data communication device, or a driver for controlling the operation of printing section 15. Together with these, in the main memory 11b, contained are softwares corresponding to a sending information managing section 11b2, an error detecting section 11b3 and an information of itself detecting section 11b4; which are features of present invention.

The sending information managing section 11b2 automatically attaches a sending information to an electronic mail, when the data communication device sends the electronic mail, so as to manage the electronic mail individually. This information is an individual information of the electronic mail. And, this is an ID (identification) which enables recognition of the electronic mail. In Embodiment 1, this information is made up of a mark of Message-Id. The content of this Message-Id can be whatever can manage individual electronic mails to send. However, the content must be what can distinguish Message-Id of other data communication devices. Therefore. Message-Id is made up of a combination of date, time and mail address.

This information is automatically attached to the sending electronic mail as its head information. Here, a content of the electronic mail, which is got back to the sender when an error occurred, is described.

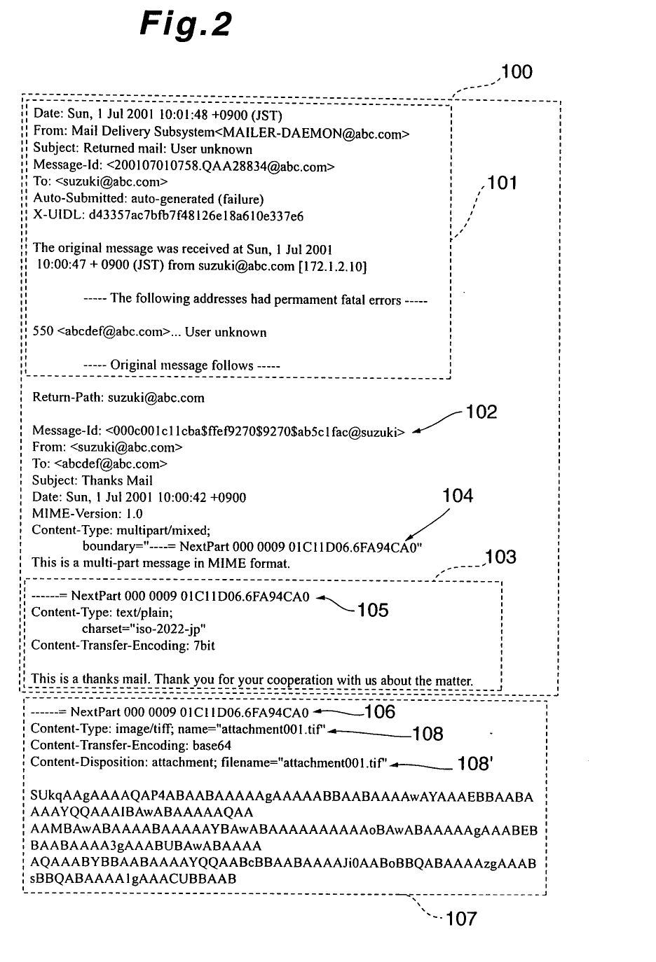

FIG. 2 shows an example of such a content of an electronic mail.

The electronic mail shown in FIG. 2 contains an information 101, which is added by a mail server. This information 101 contains a message for informing the sender that a communication error occurred, as well as the head information.

Succeeding to this information 101, returned is the electronic mail including the head information and the attached file. In this occasion, the content of the electronic mail is all the same as what has ever sent by the sender itself And, in this occasion, Message-Id contained in the head information is, for example, an information 102 shown in FIG. 2. This Message-Id is restored in a region of main memory 11b not shown in the drawings or a disk device not shown in the drawings.

The error detecting section 11b3 in FIG. 1 analyzes the content of the received electronic mail. And, it judges whether the content is informing of the occurrence of error or not. That is, it judges whether the content is what is shown in FIG. 2. As a concrete judging method, adopted is a method of detecting a letter row of “error” contained in the part of information 101 or a letter row of “failure” contained in the part of head information.

The information of itself detecting section 11b4 analyzes the content of the received electronic mail. And, it judges whether the content is same as that of the electronic mail ever sent by the sender itself. That is, it judges whether the information 102 shown in FIG. 2 (Message-Id) corresponds with the information stored in the sender itself or not. By this, it is detected that an electronic mail, which comprises what nothing is done to what has ever sent by the sender itself, has returned to the sender.

Moreover, as the sections other than these, in the main memory 11b, the working region of the microprocessor 11a is provided.

The operating section 12 comprises keyboard for the user to operate etc, so as to perform operating process such as data sending etc. according to the user's instruction.

The presenting section 13 comprises displaying device, so as to present operating situation of the user or communication result/communication record etc.

The reading section 14 comprises an image reader, so as to read the original image to send, in the occasion when the data communication device acts as an internet facsimile.

The printing section 15 comprises any kind of a printer, so as to print out the content of the received electronic mail.

The image processing section 16 performs image processing of encoding image, compressing the encoded image and expanding the compressed image data.

The LAN controlling section 17 is connected with LAN 18, so as to perform connecting control of LAN or connecting control with the internet via LAN 18.

LAN 18.

<Operation of Embodiment 1>

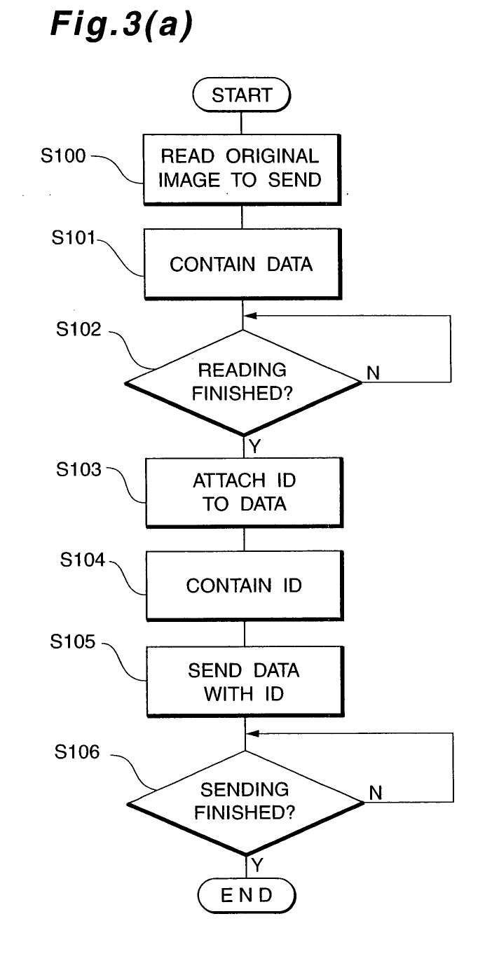

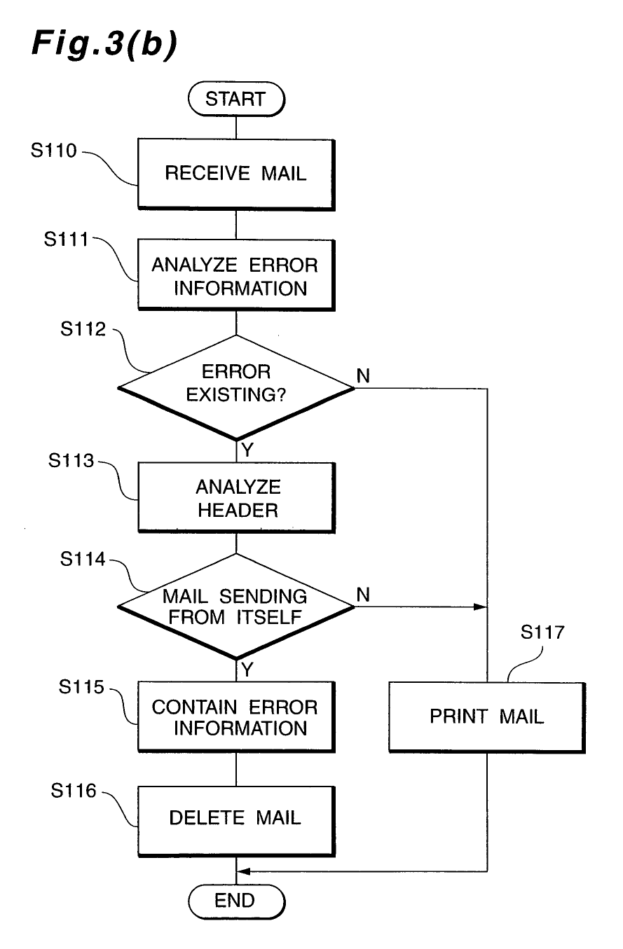

Next, the operation of Embodiment 1 is described, referring to the flowchart of FIG. 3.

When the data communication device in FIG. 1 sends an electronic mail, as shown in FIG. 3(a), at first, it reads the original image to send (S100). Then, it stores the data (S101). And, the control waits until reading is finished (S102).

When the reading is finished, the data communication device attaches an ID to the data (S103). And, it stores the ID (S104). Then, it sends the data with the ID (S15). And, the control waits until sending is finished (S106).

When the data communication device in FIG. 1 received an electronic mail (S110), as shown in FIG. 3(b), it analyzes the error information (S111). This analysis is done, as mentioned above, by searching a prescribed letter row of “error” or “failure” etc. in the information 101 in FIG. 2.

When an error is existing (S112), the data communication device analyzes the head information (S113). Then, it judges whether the content of received electronic mail is same as what it has ever sent by itself (S114). That is, the sender of the mail is the sender. This judgement is done by judging whether the information 102 in FIG. 2 accords with Message-Id kept in itself or not, as mentioned before.

When the received electronic mail contains the sender's own information, that is, both Message-Ids accord with each other, performed is an after process for dealing this electronic mail, which informs the sender that the previously sent electronic mail was not received. In Embodiment 1, the content of received electronic mail is not printed in this after process. Thus, printing same content can be avoided, when the sender keeps the sent data.

Here, the sender's data communication device may confirm whether the sent data is really kept or not. And, if it is not kept, the sender's data communication device may keep the content of received mail.

As an example of the after process, the error information is stored (S115), and the received mail is deleted (S116).

On the other hand, when the mail is not sent from the sender itself, the content of mail is printed (S117), because it is necessary for the sender to analyze the mail. An example of printed error mail is shown in FIG. 2 mentioned before. Here, the information 101 can be edited.

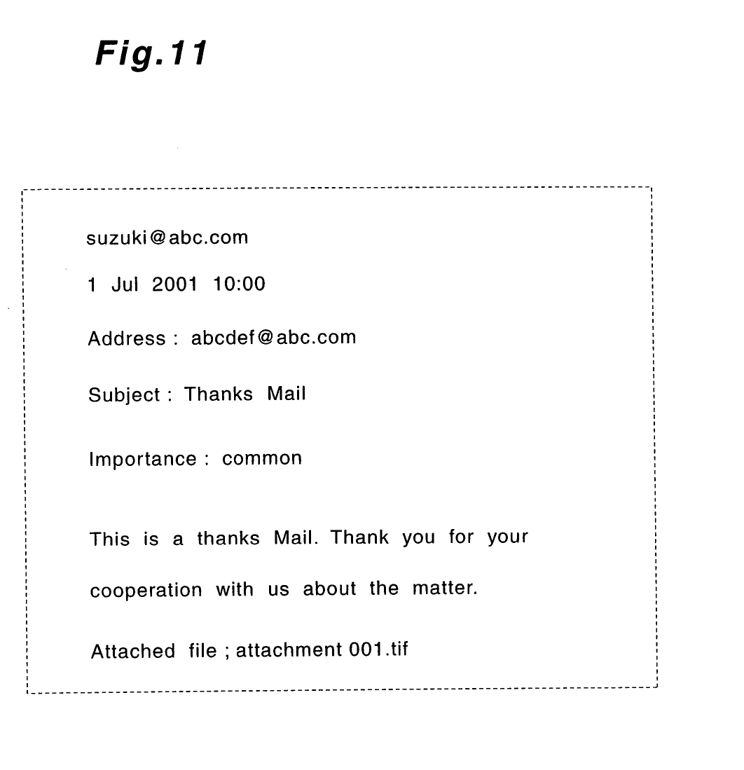

Further on the other hand, when no error exist (S112), the received mail is printed (S117). An example of printed mail is shown in FIG. 11. As shown in FIG. 11, the content of mail, which is normally received, does not contain a part of the information 101 shown in FIG. 2. Here, other parts shown in FIG. 2 are edited as shown in FIG. 11.

<Effect of Embodiment 1>

As mentioned above, according to Embodiment 1, useless printing can be excluded; because a sending information managing section 11b2 for attaching head information to the electronic mail, so as to manage it individually, an error detecting section 11b3 and an information of itself detecting section 11b4 for judging whether the received electronic mail is informing of an error of an electronic mail sent by the sender itself, are provided, and the received content is not printed at all when the judgement is affirmative.

The reason why the content is not printed at all is that what is necessary to find the file failed sending is not the content of text but Subject, sending date and time etc. which specify File and which are written in the error information.

<Embodiment 2>

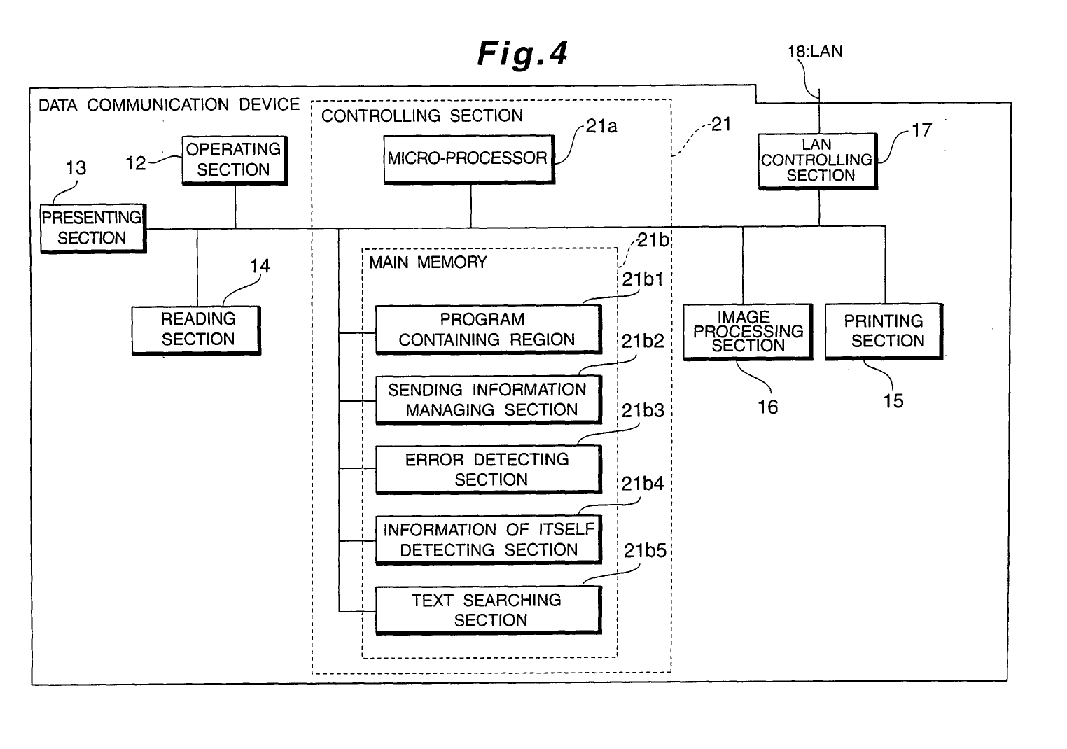

FIG. 4 shows a data communication device of Embodiment 2 of present invention.

The device shown in FIG. 4 comprises a controlling section 21, an operating section 12, a presenting section 13, a reading section 14, a printing section 15, an image processing section 16, and a LAN controlling section 17. The configuration of sections other than the controlling section 21 is same as what is described in Embodiment 1 mentioned before. So, the same symbols are given to the sections corresponding to the same sections in Embodiment 1.

The controlling section 21 comprises a microprocessor 21a and a main memory 21b. The main memory 21b contains a text searching section 21b5. This comprises a software for realizing a data communication device of Embodiment 2, together with a sending information managing section 21b, an error detecting section 21b3 and an information of itself detecting section 21b4. This software is executed read in the microprocessor 21a step by step.

The text searching section 21b5 is what searches the part of text 103, which has been sent by this device itself, from the received data shown in FIG. 2. In concrete, it takes out a boundary information 104 from the head information, so as to recognize boundaries in the received data. Here, at first, the information 102 sent by this device itself, mentioned before, is detected, in order to know the position of head information. In the example shown in FIG. 2, “----=Next Part 000 0009 01C11D06.6FA94CAO” is a boundary information 104. This is taken out, after Message-Id is detected. Then, boundary information 105, 106, which comprise the same row of letters, are searched in the received data. In this occasion, there is a part of text between the first boundary information 105 and the second boundary information 106.

And, the microprocessor 21a makes the printing section 15 print out the text 103 including the first boundary information 105 not including the second boundary information 106, when it received an electronic mail informing of communication error, which is caused by the electronic mail ever sent by this device itself. For this purpose, the program containing region 21b1, the sending information managing section 21b2, the error detecting section 21b3 and the information of itself detecting section 21b4 are installed in the main memory 21b of controlling section 21, as well as the text detecting section 21b5. These can comprise the program containing region 11b1, the sending information managing section 11b2, the error detecting section 11b3 and the information of itself detecting section 11b4 in Embodiment 1. So, the same description is omitted.

<Operation of Embodiment 2>

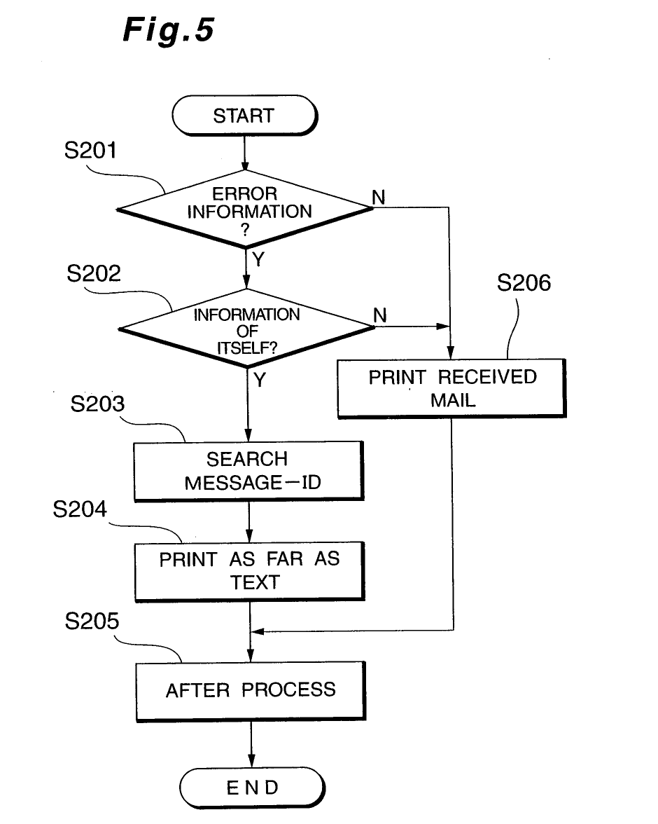

Next, operation of Embodiment 2 is described, referring to the flow-chart of FIG. 5.

When the data communication device in FIG. 4 received an electronic mail; the microprocessor 21a of controlling section 21, at first, judges whether the content of received electronic mail is an error information or not (S201), as shown in FIG. 5. This judgement is done by searching a prescribed letter row in the information 100 of FIG. 2, as described in the description of configuration of Embodiment 1. When it is judged that the mail is an error information, the control proceeds to the next step S202. Otherwise, the electronic mail is printed (S206).

On the other hand, at step S202, it is judged that the content of received electronic mail is what the sender itself has ever sent or not. This judgement is done by judging whether the information 102 of FIG. 2 accords with the letter row kept in the sender itself or not. When the content is the sender's information, the control proceeds to the next step S203. Otherwise, the electronic mail is printed (S206), because it is conceived that analysis of the electronic mail is necessary.

On the other hand, at step S203, Message-Id is searched for. And, boundary information 105, 106, which are same as the boundary information 104, are searched for. Then, the part of text 103 is detected. And, at the succeeding step S204, only the part of information 100 shown in FIG. 2 is printed out by the printing section 15.

Finally, at step S205, an after process of the electronic mail is performed. An example of the after process is to delete the received electronic mail from the memory or to store the result of receiving of error information in the memory etc.

Incidentally, in the flow-chart of FIG. 5 mentioned above, step S201 and step S202 can be replaced with each other, as a varied embodiment.

<Effect of Embodiment 2>

As described above, according to Embodiment 2, if the sender wants to know the content of text at once, only the content of the part of text can be printed. Therefore, useless printing of other part can be excluded. Since, a sending information managing section 21b2 for including an information used for managing each electronic mail individually, in the head information attached to the head information; an error detecting section 21b3 and an information of itself detecting section 21b4 for judging whether the received electronic mail is informing the sender of an communication error of the mail sent by the sender itself or not; and a text searching section 21b5 for searching the pat of text 103 of data sent by the sender itself, from the received mail.

<Embodiment 3>

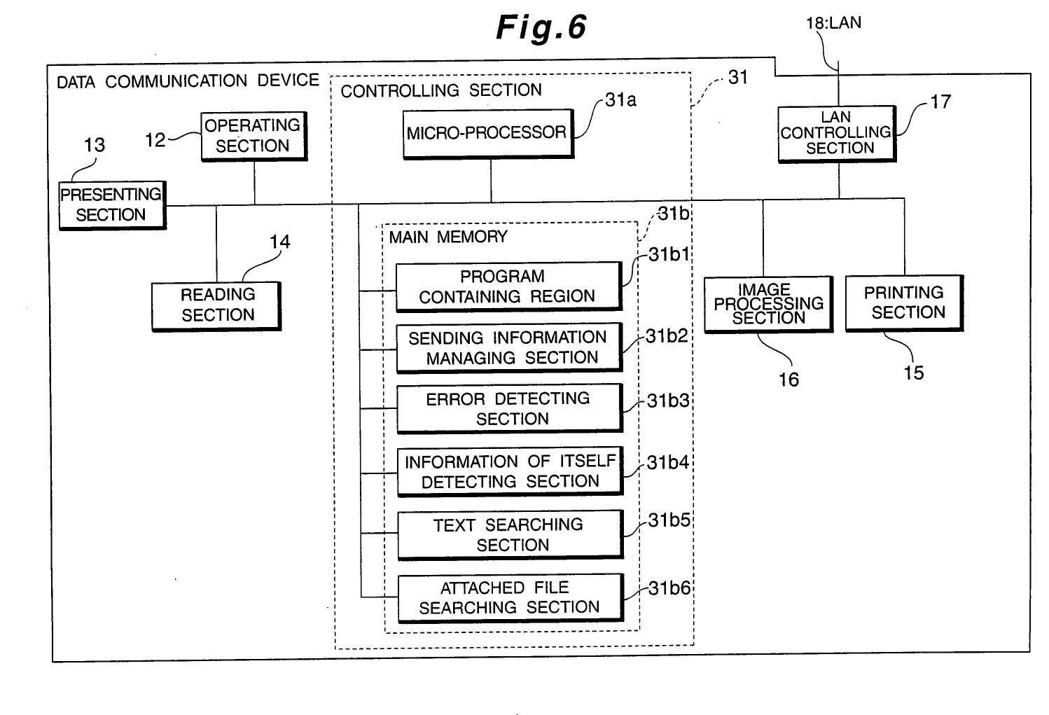

FIG. 6 shows a data communication device of Embodiment 3 of present invention.

The device shown in FIG. 6 comprises a controlling section 31, an operating section 12, a presenting section 13, a reading section 14, a printing section 15, an image processing section 16, and a LAN controlling section 17. The configuration of sections other than the controlling section 31 is same as what is described in Embodiment 1. So, the sections corresponding to those having same configuration are designated with the same symbols. And, the duplicating description is omitted.

The controlling section 31 comprises a microprocessor 31a and a main memory 31b. The main memory 31b contains an attached file searching section 31b6. This comprises a software for realizing a data communication device of Embodiment 3, together with a sending information managing section 31b2, an error detecting section 31b3, an information of itself detecting section 31b4 and a text searching section 31b5. This software is read out step by step, being executed in the microprocessor 31a.

The attached file searching section 31b6 is what searches the received data shown in FIG. 2 for the part of attached file sent by the sender itself. In concrete, the boundary information 104, which is included in head information of data sent by the sender itself, for recognizing boundaries of data, is taken out by the attached file searching section 31b. And, it searches the received data for the boundaries. Here, at first, the information 102 sent by the sender itself is found, in order to know the position of head information.

In the example shown in FIG. 2, “----=NextPart 000 0009 01C11D06.6FA94CA0” is the boundary information 104. And, this is taken out, after finding Message-Id. Then, the received data is searched for boundary information 105, 106, comprising the same letter row. In this occasion, two-boundary information 105, 106 are found. And, there is an attached file's part 107 next to the second boundary information 106. And, the attached file searching section 31b searches the attached file's part 107 for the file name 108. In concrete, the file name is extracted from the data field indicated by a letter row of “name=” written next to a letter row of “Content-Type”. In the example of FIG. 2, the file name is a letter row of “attachment001.tif”. Or, instead, a file name 108′ can be extracted from the data field indicated by “Content-Disposition:attachment;filename=”.

And, the microprocessor 31a receives an electronic mail informing of a communication error. When the error has been caused by the sender's own mail ever sent, the file name 108 is printed out as well as the information 100, including the text 103 between the boundary information 105, 106. For this purpose, a program containing region 31b1, a sending information managing section 31b2, an error detecting section 31b3, an information of itself detecting section 31b4 and a text searching section 31b5 are stored in the main memory 31b of controlling section 31, as well as the file searching section 31b6 mentioned above. These can comprise the program containing region 11b1, sending information managing section 11b2, error detecting section 11b3, information of itself detecting section 11b4 in Embodiment 1, and the text searching section 21b5 in Embodiment 2. So, their descriptions are omitted, since they are same.

<Operation of Embodiment 3>

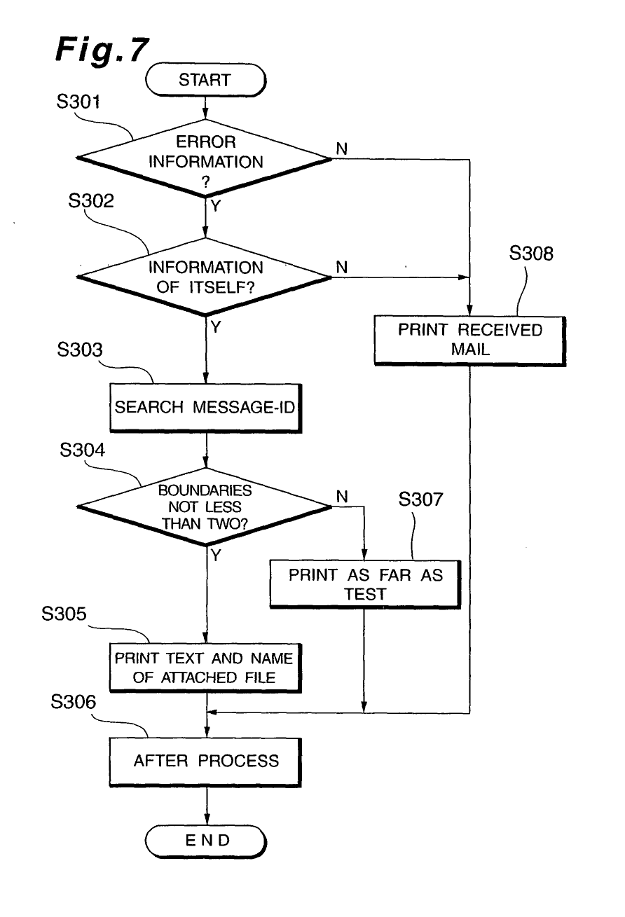

Next, operation of Embodiment 3 is described, referring to the flow-chart of FIG. 7.

When the data communication device of FIG. 6 received an electronic mail; at first, it judges whether the received mail is informing of an error or not (S301) as shown in FIG. 7. This judgement is same as what is described in Embodiment 1. When it judged that it is informing of an error, the control proceeds to the next step S302. Otherwise, the mail is printed (S308).

On the other hand, at step S302, the device judges whether the content of received mail is same as what has ever sent by this device itself. This judgement is same as what is mentioned before. If it is same as that of this device, the control proceeds to the next step S303. Otherwise, the mail is printed (S308), because an analysis of the mail is necessary.

On the other hand, at step S303, the mail is searched for Message-Id. And, the mail is searched for boundary information 105, 106, which are same as the boundary information 104. Then, the part of text 103 is found. And, at the succeeding step S304, it is judged whether there are two boundary information 105, 106. If there are not two, that is, there is only one; only the part of information 100 shown in FIG. 2, including text sent by this device, is printed out (S307).

On the other hand, if there are two boundary information 105, 106; at step S305, the information 100 shown in FIG. 2 and the name of attached file are printed out.

Finally, at step S306, an after process of the electronic mail is performed. An example of the after process is to delete the received mail from the memory or to store the record of error received in the memory as mentioned before.

Incidentally, the flow-chart of FIG. 7 can be varied similarly as the flowchart of FIG. 5.

<Effect of Embodiment 3>

As described above, according to Embodiment 3, when an electronic mail attaching file is received, only the part of text and the name of attached file can be printed out. So, useless printing is excluded. Since, an attached file searching section 31b6, which searches the mail for the part of text, and a text searching section 31b5, which searches the mail for the name of attached file, are provided as well as a sending information managing section 31b2 for including management information of individual mail in head part of mail, and an error detecting section 31b3 and an information of itself detecting section 31b4 for judging whether the received mail is informing of an error caused by the mail ever sent by the sender itself

<Embodiment 4>

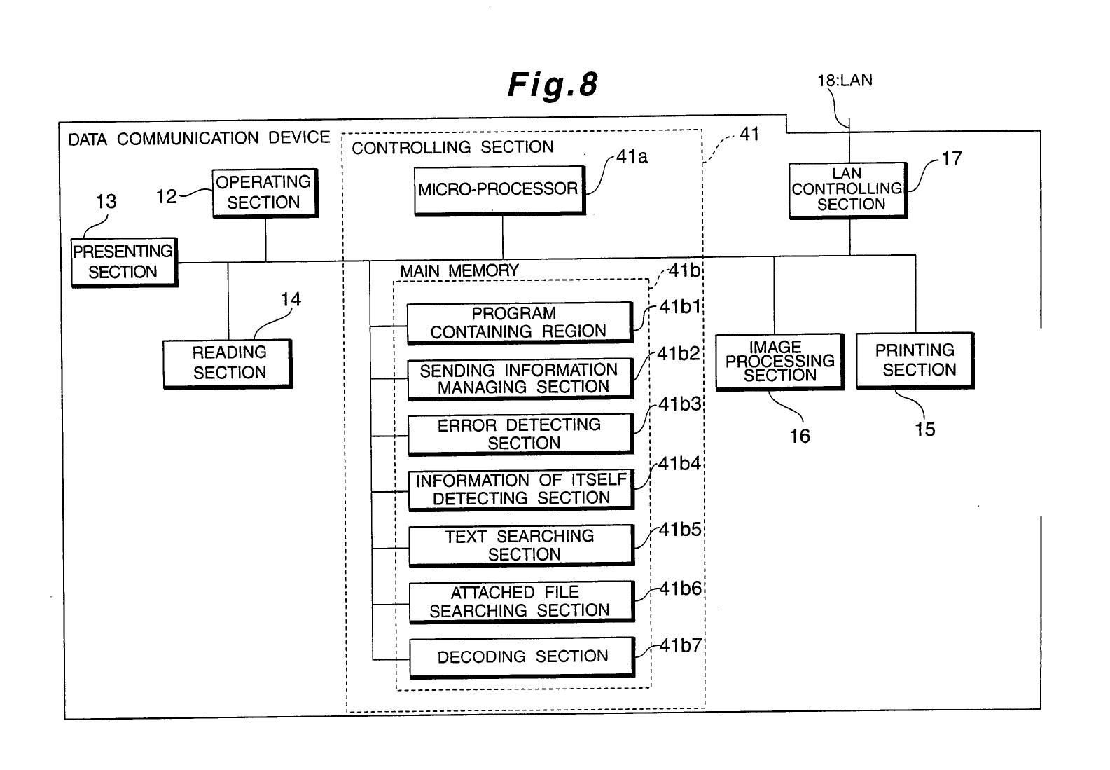

FIG. 8 shows a data communication device of Embodiment 4 of present invention.

The device shown in FIG. 8 comprises a controlling section 41, an operating section 12, a presenting section 13, a reading section 14, a printing section 15, an image processing section 16, and a LAN controlling section 17. The configuration of sections other than the controlling section 41 is same as the corresponding sections of Embodiment 1. So, the same sections are designated with the same symbols. And, duplicating description is omitted.

The controlling section 41 comprises a microprocessor 41a and a main memory 41b. The main memory 41b contains a decoding section 41b7. This comprises a software for realizing the data communication device of Embodiment 4, together with a sending information managing section 41b2, an error detecting section 41b3, an information of itself detecting section 41b4, a text searching section 41b5, and an attached file searching section 41b6. This software is executed by the microprocessor 41a, reading it step by step.

The decoding section 41b7 is what decodes the encoded data of attached file's part 107 sent by this device itself and found in the received data shown in FIG. 2. In concrete, this decoding process is done, after confirming the recognized file format and encoding formula included in the head information of attached file sent by this device itself. In the example of FIG. 2, it is judged that the file format is tiff (tag image file format), referring to the data field indicated by a letter row of “Content-Type:” and that the encoding formula is Base 64, referring to the data field indicated by a letter row of “Content-Transfer-Encoding”

And, the microprocessor 41a prints out a decoded image data together with its file name by the printing section 15 as well as the information 100 between the first boundary information 105 and the second boundary information 106; when it received an electronic mail informing of a communication error and the error was caused by a mail ever sent by this device itself. For this purpose, a program containing region 41b1, the sending information managing section 41b2, error detecting section 41b3, information of itself detecting section 41b4, text searching section 41b5, and attached file searching section 41b6 are provided in the main memory 41b of controlling section 41, together with the decoding section 41b7. The configurations of these sections are same as those of the program containing region 11b1, sending information managing section 11b2, error detecting section 11b3, information of itself detecting section 11b4 in Embodiment 1, the text searching section 21b5, in Embodiment 2, and the file searching section 31b6 in Embodiment 3. So, the duplicating description is omitted.

<Operation of Embodiment 4>

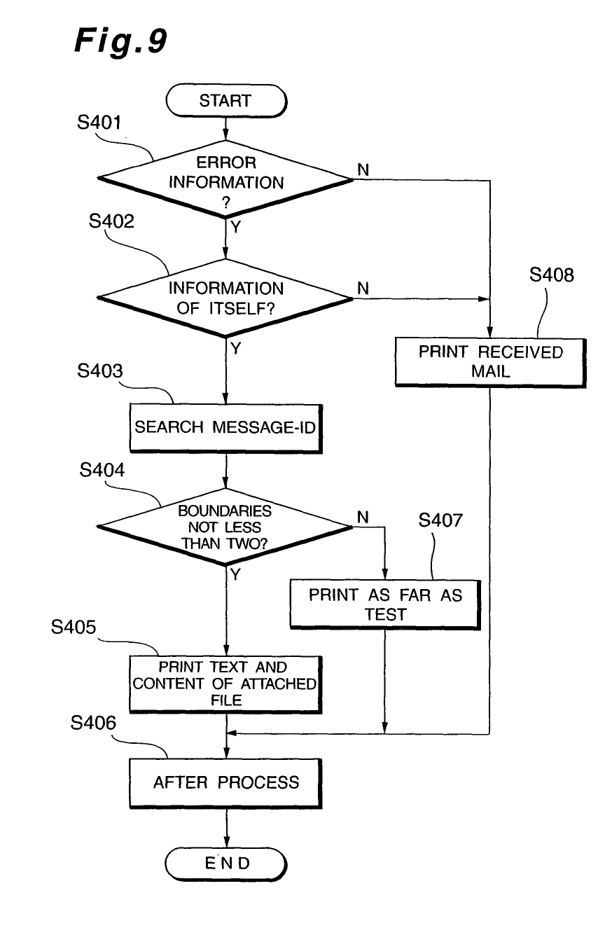

Next, the operation of Embodiment 4 is described, referring to the flowchart of FIG. 9.

When the data communication device of FIG. 8 received an electronic mail; as shown in FIG. 9, at first, it judges whether the content of received mail is an error information or not (S401). If it judged that it is an error information, the control proceeds to the next step S402. Otherwise, the electronic mail is printed (S408).

On the other hand, at step S402, it is judged whether the content of received mail is the information ever sent by this device itself or not. If it is not the information of this device itself; the mail is printed (S408), because it is necessary for the sender to analyze the mail.

Otherwise, that is, it is the information of this device itself; at step S403, Message-Id is searched for. And, boundary information 105, 106, which are same as boundary information 104, are searched for. Then, the part of text 103 is detected. And, at the succeeding step S404, it is judged whether there are two boundary information 105, 106. If there is only one boundary information 105; only the part of information 100, that includes the text sent by this device itself, is printed out by the printing section 15 (S407).

On the other hand, if there are two boundary information 105, 106; at step S405, the part of information 100 shown in FIG. 2, the name of attached file 108, and an image data decoded from the attached file, are printed out.

Finally, at step S406, an after process of electronic mail is performed. Examples of after process are, as mentioned before, to delete the received electronic mail from the memory or to store record of received error information etc.

Incidentally, in the flow-chart of FIG. 9 referred above, steps S401 and S402 can be replaced with each other. Moreover, printing of the name of attached file can be omitted, relying on the printing of decoded content of attached file.

<Effect of Embodiment 4>

As described above, according to Embodiment 4, useless printing can be excluded, as image data is decoded when it is printed. And, this is printed, occasionally with the part of text or the name of attached file. Since, a sending information managing section 41b2 for including management information in the head information of electronic mail, so as to manage the sent mails individually; an error detecting section 41b3 and an information of itself detecting section 41b4 for judging whether the received electronic mail is informing of an error caused by the mail ever sent by this device itself; a text searching section 41b5 and an attached file searching section 41b6 for searching the content of the received mail for the part of text 103 and the name 108 of attached file respectively; and a decoding section 41b7 for decoding the attached file; are provided.

<Other Description of Embodiments 1 to 4>

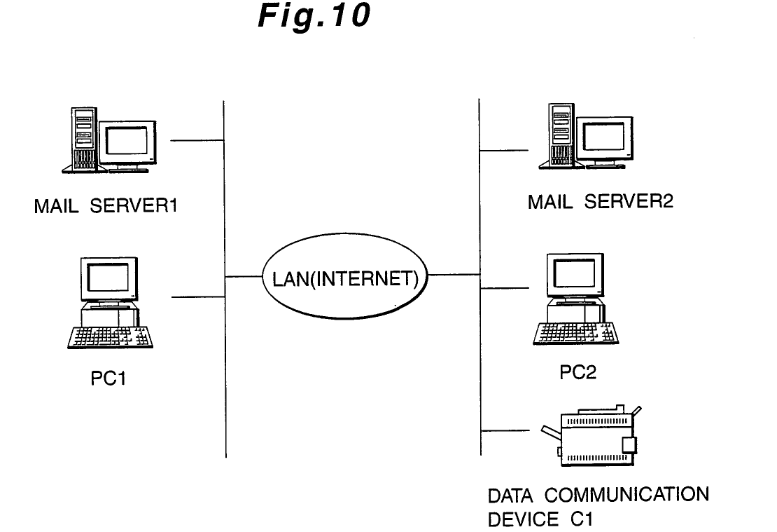

FIG. 10 shows an example of system where the data communication device of Embodiments 1 to 4 are provided.

In FIG. 10, a data communication device C1 is connected with LAN or Internet. This device is able to send or receive electronic mails, via a mail server 1 with a personal computer PC1 or via a mail server 2 with a personal computer PC2. Here, in FIG. 10, the data communication device intends to send PC1 an electronic mail attached with a file. However, a certain communication error occurs. And, an electronic mail informing of the error is sent from a mail server to the data communication device C1. In this occasion, the data communication device C1 automatically judges whether the error is caused by an electronic mail sent by this device itself or not. And, it controls the output, that is, it avoids printing the content of the received mail of error information, it prints only the part of text, or it prints the name of attached file or decoded content of the file.

<Other Embodiments>

As mentioned above, Embodiments 1 to 4 comprised individually. However, the present invention is not limited to this. And, it is realized by another Embodiment made up for selecting either of Embodiments 1 to 4. Moreover, in above Embodiments, the output control is processed for error mails. However, for normal electronic mails, the present invention can be used as well. That is, when a sender sent a mail to a receiver normally and the receiver send a mail including the original content sent by the sender to the sender in normal process; the content can be detected by the information of itself detecting section, so as to cancel the output, for example, printing the content at the sender.

In each Embodiment mentioned above, the sending information managing section 11b2, 21b2, 31b2, 41b2 is made up for attaching automatically an identification of this device's data, so as to send the data. However, the present invention is not limited to this. The sending information managing section 11b2 etc. can be omitted. That is, there can be a communication device which attaches an identification by itself to the sending data. Then, the function of this device avails the present invention. And, it is possible to omit the section. Moreover, the device of present invention is realized by a software. However, instead of this, ASIC can be used for realizing present invention by a hardware.

Further, in Embodiments mentioned above, the device printing the received data was described. However, present invention is not limited to this. It can be embodied in a device presenting the received data at a display. In this occasion, the content of presentation becomes easy to understand for the user.

Although, Embodiments mentioned above are described about electronic mail, the present invention can also be applied to data communication between computers such as personal computer, or data communication between facsimiles.

What is claimed is:

1. A data communication device comprising
a data receiving section for receiving data,
at least one data outputting section for putting out said data,
an its own information detecting section for detecting information which indicates that the sender of said data is the sender, and
a controlling section for limiting output of said data to said data outputting section when said its own information detecting section detected said information indicating that the sender of said data is the sender.

2. A data communication device according to claim 1, wherein said data outputting section is a presenting section.

3. A data communication device according to claim 1, wherein said data outputting section is a printing section.

4. A data communication device according to claim 1; wherein said controlling section does not put out said data to said outputting section, when said its own information detecting section detected said information indicating that the sender of said data is the sender.

5. A data communication device according to claim 4; wherein said data is contained in a containing area of memory, and said controlling section deletes said data from said containing area when the controlling section does not put out said data to the data outputting section.

6. A data communication device according to claim 1, further comprising an error detecting section for detecting information which indicates that an error in communication of said data was committed, wherein
said controlling section limits output content of said data, when an error was detected by said error detecting section and an information indicating that the sender of said data is the sender was detected by said its own information detecting section.

7. A data communication device according to claim 6, wherein
said error detecting section extracts the communication error information from said data, so as to put it out to said controlling section, and
said controlling section puts out the communication error information inputted from said error detecting section to said outputting section, when an error was detected by said error detecting section and an information indicating that the sender of said data is the sender was detected by said its own information detecting section.

8. A data communication device according to claim 7, wherein said its own information detecting section extracts said its own information from said data.

9. A data communication device according to claim 6, wherein
said data receiving section is an electronic mail receiving section for receiving electronic mails, further comprising
a sending information managing section for attaching an individual information of said data, which is used by said its own information detecting section, so as to judge whether said data contains the information indicating that the sender of the data is the sender or not, wherein
said controlling section does not put out said data to said outputting section, when an error was detected by said error detecting section and an information indicating that the sender of said data is the sender was detected by said its own information detecting section.

10. A data communication device according to claim 9, further comprising
a text searching section for searching part of text from said data, wherein
said controlling section puts out the part of text and error information which is contained in said data, when an error was detected by said error detecting section and an information indicating that the sender of said data is the sender was detected by said its own information detecting section.

11. A data communication device according to claim 10, further comprising
an attached file searching section for searching part of attached file from said data, wherein
said controlling section puts out the part of text, name of attached file and error information, which is contained in said data; when an error was detected by said error detected section, an information indicating that the sender of said data is the sender was detected by said its own information detecting section and at least one file was attached to said data.

12. A data communication device according to claim 11, further comprising
a decoding section for decoding encoded file after detecting the encoding formula of the file attached to said data, wherein
said controlling section puts out the part of text, the content decoded from the attached file and error information, which is contained in said data; when an error was detected by said error detecting section, an information indicating that the sender of said data is the sender was detected by said its own information detecting section and at least one file was attached to said data.

13. A data communication device comprising
a data receiving section for receiving data,
at least one data outputting section for putting out said data,
a data dividing section for dividing said data after recognizing each part of said data, and
a controlling section for editing said each part of data selectively according to an arrangement offered by the user, so as to put it out to said outputting section.

14. A data communication method for detecting information which indicates that the sender of said data is the sender, when an error information is detected from a received data; and limiting output of said received data according to the result of the detection.

15. A data communication method according to claim 14, wherein limiting output of said received data is to change expression of the output of said received data.
